(19) United States
(12) Patent Application Publication
(10) Pub. No.: US 2010/0198675 A1
(43) Pub. Date: Aug. 5, 2010

(54) METHOD FOR INTERACTION BETWEEN A USER AND A RECEIVER OF A PRINTED PRODUCT

(75) Inventor: Heinz Möckli, Grut (CH)

Correspondence Address: PAULEY PETERSEN & ERICKSON, 2800 WEST HIGGINS ROAD, SUITE 365, HOFFMAN ESTATES, IL, 60169, US

(73) Assignee: Ferag AG, Hinwil (CH)

(21) Appl. No.: 12/451,882

(22) PCT Filed: Mar. 11, 2008
(86) PCT No.: PCT/CH2008/000105

§ 371 Date: Apr. 1, 2010

(30) Foreign Application Priority Data
Jun. 4, 2007 (CH) 886 07

(51) Int. Cl. G06Q 30/00; G06K 7/01; G06Q 10/00; G06Q 99/00; G06K 19/067

(52) U.S. Cl. 705/14.26; 340/10.41; 340/10.42; 340/10.51; 705/18; 705/28; 705/325; 235/492

(57) ABSTRACT

The invention relates to a method for interaction between a user (32, 24), for example, a newspaper publisher, and at least one receiver (A, B, C) to whom a printed product (12, 23, 23a, 23b, 23c, 26) comprising at least one RFID tag (14, 14a, 14b, 14c) is delivered. At least one specific piece of additional information (a, b, c, 42) is stored in at least one RFID tag (14, 14a, 14b, 14c) for the purposes of interaction.

### BACKGROUND OF THE INVENTION

1. Field of the Invention

The present invention relates to a method for interaction between at least one user and at least one recipient of at least one printed product in accordance with the preamble of patent claim 1, to printed products in accordance with the preamble of patent claim 23, and to a system for carrying out the method in accordance with the preamble of patent claim 24.

2. Discussion of Related Art

The prior art discloses radiofrequency identification transponders (subsequently called RFID tags), and the use of these in smart labels (also called RFID for short) is becoming increasingly important. The basic principles of RFID technology, which allows data to be transferred contactlessly and without visual contact between an RFID tag and a transceiver by means of radio waves are known and do not need to be explained further at this juncture.

The systems for wireless data transmission, for example for identifying products provided with RFID tags, usually comprise the following three components: an RFID tag, a transceiver, which is used to read data from the tag or to write them to the tag, and a superordinate IT system which manages the relevant data. Among the RFID tags, a distinction is drawn in respect of their power supply between passive, semiactive and active RFID tags, the text below only discussing the passive RFID tags in more detail, which draw their energy from the electromagnetic field which is generated by the transceiver and received by means of inductive or capacitive coupling in the near field via the antenna. The systems with inductive coupling currently operate primarily in low frequency bands from 30 to 500, preferably 100 to 135 kHz with a range of up to 1 meter and in high frequency bands from 3 to 30, preferably of 13.56 MHz, with a range of approximately 1.7 meters. In similar fashion to the frequency band, both the data transmission rates and the purchase prices are low for the low frequencies (LF). LF-RFID tags are usually fitted with chips having a storage capacity of up to 2 kbits. In the case of the high frequencies (HF), which have higher data transmission rates but also a higher price, the range likewise corresponds to approximately 1.7 meters. Depending on the memory type, the available storage space ranges from the storage of simple identification numbers to the storage of complex data, such as manufacturer, best before date, date of manufacture, selling prices, etc.

WO 05/062222 A1 from the company Brother Kogyo Kabushiki Kaisha. shows a system in which a mobile telephone equipped as an RFID reader (information terminal) is used to read (link) information from an RFID tag which is associated with an advertising bill. On the basis of this (link) information, further (advertising) information associated with the (link) information can be transmitted from a background system to the mobile telephone.

WO 2006/137740A1 from the company Telenor ASA likewise shows a system and a corresponding apparatus in which a mobile telephone with an RFID reader can be used to read an RFID tag and a network (WLAN) can be used to transmit or process additional information associated with the RFID tag.

WO 2004/004196A1 from the company Nokia Corporation shows a transmission/reception unit (transceiver) whose hardware can be configured by means of software in self-adaptive fashion both as an RFID reader, for communication by means of RFID tags, and as a Bluetooth transceiver.

Swiss patent application No. 00795/07 from the applicant discloses printed products which are preferably produced using a conventional printing method, for example forme-bound using rotary printing, and are provided with an identification means in the form of an RFID tag. By way of example, the identification means carries a multibit information element for identifying the products and a control information element which controls at least one work step in the print further processing. The work step may comprise one of the following activities: conveying, storing, inserting, gathering, assembling, stapling, paging, placing inserts, sticking, cutting, addressing or packaging. The work step may also be an inspection step. On the basis of preferred embodiments of the Swiss patent application No. 00795/07, multi-part printed products are produced which comprise at least one main product and/or one or more subproducts. Subproducts may also be understood to mean inserts, postcards or advertising product supplements, for example CDs, DVDS, CD-ROMs and other data storage media. At least one of the main and/or subproducts, inserts, postcards, advertising supplements etc. is provided with an RFID tag which has at least one 1-bit control information element and/or at least one product information element which controls at least one work step directly or indirectly in the print further processing. For smart multibit RFID tags, provision is made for these to have product and/or control information written to them preferably following creation on the product which is to be provided with the tag or, in the case of separately created RFID tags, following application to the product which is to be provided with the tag.

Swiss patent application No. 00795/07 proposes the use of an address information element, stored in the RFID tag, for a subscriber in order to provide a printed product with addressee-specific advertising, for example advertising letters addressed personally or preaddressed response cards. In the area of assembly, this can be done, by way of example, by inserting target-group-specific high-quality conventionally produced advertising inserts, sticking in exactly the same postcards, vouchers or product samples.

The high-quality RFID tags, which can store text, audio or even picture and video files, comprise a powerful IC and are preferably not printed onto the printed products but rather are produced separately and stuck onto the printed products or connected thereto in another way. This can be done very elegantly, for example, using apparatuses as are known from EP1106550, EP1086914 and EP1275607 from Ferag AG and are established on the market extremely successfully under the trade mark MEMOSTICK®.

Despite the large number of known systems for interaction between a user and at least one recipient of a printed product, the users, that is to say publishers and advertising customers, for example, have an enormous need for methods and products which allow new and/or improved forms of interaction between users and recipients.

### SUMMARY OF THE INVENTION

It is therefore the object of the present invention to provide a method for interaction between a user and at least one recipient of a printed product which allows a supplementary benefit to be generated for sender and recipient by means of the interaction.

It is a further object of the invention to provide methods which avoid the drawbacks of the methods known from the prior art.

The invention also has the task of simplifying the interaction between sender and recipient with widespread use of known technology in the field of electronic communication means, particularly mobile telephones and personal computers.

These objects are achieved by a method for interaction between a user and at least one recipient having the features of claim 1, by a printed product having the features of claim 23 and by a system having the features of claim 24.

The invention is distinguished in that, for the interaction between at least one user and at least one recipient, a printed product which comprises at least one RFID tag which stores at least one specific supplementary information element in electronic form is delivered to a recipient.

In a first embodiment of the present invention, products, for example printed products, also called printers' products, are created in a production process and are then transported using a conveyor means to a product further processing section. The conveyor means is not denoted in more detail here and may be a clamp conveyor, for example. The form of the conveyor means has a subordinate role for understanding the present invention, however. The product has either already been provided with an RFID tag, which in the present case has a first memory area and a second memory area, during the production process or is provided with a separately produced RFID tag during the further processing. In the present embodiment, a first memory area is used for holding at least one information element, required during the product further processing. In this regard, reference will be made at this juncture to the application CH 00795/07 from the applicant dated May 14, 2007.

In the present case, a second memory area is provided with an information element, subsequently also called specific supplementary information element, which specifies the printed product or end product. Such supplementary information elements may be addressee-specific information elements such as residential address, business address, customer numbers, subscriber numbers, society memberships and the like, for example. In line with advantageous embodiments, the specific supplementary information element has already been put onto the RFID tag during the production process, that is to say has been written into the tag, for example. Alternatively, the production process first of all involves the creation of an empty RFID tag into which the specific supplementary information element is written into the memory downstream at a writing station. When the actual product further processing is at an end, the finished printed products with the RFID tags leave the product further processing apparatuses in the direction of conveyance and are assigned to various distribution or dispatch channels by a distributor, so that they are ultimately delivered to various recipients. Each of the recipients obtains an end product which comprises at least one RFID tag. In this embodiment, the end products with the respective RFID tag are nonspecific, that is to say that the end product which has been delivered to recipient A, for example, does not differ from the end product which has been delivered to recipient B and/or C and/or to further recipients. All recipients have accordingly obtained an identical end product with an identical specific supplementary information element. The use of this specific supplementary information element, and the interaction with the recipients based on the supplementary information elements, will be discussed in detail below.

A user, subsequently a publishing house or a publisher, for example, has the option, in accordance with a further embodiment, of providing RFID tags with customer-specific supplementary information elements. By way of example, this is done on behalf of one or more advertising customers, the RFID tags provided with the customer-specific supplementary information element having been fitted to specific products/subproducts, preferably in the form of printed products.

In line with further advantageous embodiments, an advertising customer has certain specific supplementary information elements put onto products/subproducts on a customer- and/or addressee- and/or recipient-specific basis. In this case, a first specific supplementary information element can be delivered to a first recipient, and a further or second specific supplementary information element can be delivered to a second or further recipient, and so on. In this embodiment, it is thus possible to send particular specific supplementary information elements to predetermined recipients or recipient groups. In line with the preferred embodiment of the invention, this involves a main product, which has been individualized by means of a subproduct, provided with an RFID tag, from the advertiser being provided with the desired specific supplementary information elements on a customer-specific basis. The subproduct with the RFID tag is inserted or stuck into the neutral main product, preferably a nonindividualized newspaper, periodical or other printers' product, at a suitable workstation. The subproduct with the specific supplementary information element, together with the main product, forms what is known as an end product. In this case, the end products are individualized using specific supplementary information on the respective RFID tags. Downstream, the individualized end products are delivered to the relevant recipients at a distributor station using various distribution channels. All the recipients obtain an end product with an identical main product and a subproduct which, although it does not differ from the other subproducts in terms of the visually ascertainable information, does differ therefrom in terms of the specific supplementary information which is stored on the respective RFID tags. In one preferred embodiment of the present invention, possible use of this specific supplementary information arises when—as a representative of other recipients or recipient groups—recipient A, for example, decides to return the subproduct to the user, that is to say the publisher or advertising customer, said subproduct being in the form of a prefilled, preferably prefranked, response card, for example. The recipient is provided with an extremely convenient way of starting to interact with the user and of using this acknowledgement to the user, that is to say to the advertiser and/or publisher, to request a trial subscription or the like, for example, without the need to write his address on a response card manually. The user can just as conveniently read the recipient information stored digitally in the RFID tag and perform the further steps of the interaction on a recipient-specific basis.

A person skilled in the art can see that the subproduct with the specific supplementary information element may also be in the form of a competition participation card, a coupon or a voucher or the like.

In one inventive embodiment of the method, the printed product is a multipart printed product which comprises at least one main product and one or more subproducts, wherein at least one of the main and/or subproducts, particularly inserts, postcards and/or advertising samples, is provided with the at least one RFID tag.

In a further inventive embodiment of the method, the multipart printed product is a printed product compiled individually for a recipient, and the specific supplementary information element in the RFID tag is a recipient-specific supplementary information element.

It is thus possible to implement a method for interaction between a user and at least one recipient which is characterized in that the product delivered to the recipient comprises at least one RFID tag whose memory stores at least one specific supplementary information element in electronic form.

A person skilled in the art can see without doubt that the recipient of such an individualized end product with the specific supplementary information element reserves the right to start interacting with the sender or not. In the present example, the specific supplementary information element is a coded recipient or sender information element, for example, which a publisher uses to associate the response card—which is physically anonymous per se and separately and which has not been changed by the recipient in any way—with the recipient of the individualized end product again after said response card has been obtained. The publisher obtains digitally readable information about which recipients have started to interact with it and which have not. It can use this information to alter and/or optimize the strategy for future advertising campaigns and/or for finishing work for such interacting recipients.

In a further, particularly preferred embodiment of the present invention, the recipient of a specific supplementary information element is able to convey his acknowledgement not to the sender or producer of the individualized end product in the form of a printed product with the specific supplementary information element but rather to a third party, preferably an advertising customer, which is separate from the publisher. In this case, this advertising customer can enter specific supplementary information elements, with which an individualized product or subproduct that it requires is intended to be provided, in a database in a data format which is not denoted in more detail. This database is preferably associated with the publisher or further processor. This database preferably contains a plurality of information elements from a plurality of recipients. These information elements may contain region-specific, user-specific and/or addressee-specific supplementary information elements which are intended to be selectively delivered to particular recipients in order to increase the effectiveness of such individualized advertising. The desired individual information element is taken from recipient profiles in the database and is converted into the specific supplementary information element which the publisher enters into the memories of the relevant RFID tag. With regard to the writing process and the measures required for this, reference will again be made at this juncture to the application CH 00795/07 from the applicant dated May 14, 2007. A workstation—not denoted in more detail—is now used to combine the subproducts individualized by means of specific supplementary information elements with a main product to form an end product. In this way, it is possible to produce individualized end products for the various recipients or recipient groups. In this context, explicit reference is made to the fact that the individualization can be achieved in the present case merely by virtue of the different specific supplementary information on respective RFID tags. This results in end products which—as are already described in the preceding embodiment—are identical in terms of the visually ascertainable information on the printed products but differ in the specific supplementary information on the respective RFID tags.

It is again up to the recipient of such individualized end products with specific supplementary information whether or not to make contact with the user or the advertising customer. Preferably, the recipient sends the subproduct, specified as a response note, with the specific supplementary information to the advertising customer. The advertising customer is now able to read the specific supplementary information on the response card or the returned subproduct and to make further use thereof, preferably by returning this specific supplementary information, which preferably contains recipient details in coded form but no directly usable name or address details for the interacting recipient, to the aforementioned database. The database associates the coded recipient statement with a database entry and generates data for the recipient which are able to be read by the advertising customer and are preferably decrypted or conditioned for further use by said customer, for example said recipient's telephone number, fax number, e-mail address, residential address, business address or the like or a combination thereof, or releases the relevant information for access and download by the advertising customer. At the same time, the recipient profile in the database has the additional information added that said recipient has reacted to the advertising letter from the advertising customer. The advertising customer is thus provided with address information from potential customers which is simple to process further, and the publisher can continually increase the value of its recipient database. The first recipient profile from a recipient, which was created with the publisher in the database when a recipient subscribed to a periodical, for example, is of limited value to potential advertising customers. The advertising customer has a fundamental interest in using its budget as efficiently as possible and addressing the correct target group with its advertising means. The validity of a recipient database which comprises only address information has only limited suitability for this, since it provides only a few indirect indicators regarding the consumer behavior and personal interests and preferences of a recipient or of a recipient's household. If every reaction by the recipient is now recorded, however, it is possible to add to the recipient profile over time and to reevaluate it with specific information regarding the frequency of reaction by the recipient, for example. These data can be used to calculate a reaction probability for a particular recipient, that is to say an interaction probability with the advertising customer. On the basis of the present invention, an advertising customer can be provided with a made-to-measure recipient selection which allows it to significantly increase efficiency, that is to say the response from its advertising campaign. The advertising customer, for its part, can use the unencrypted recipient data to subsequently add a specific subsequent information element or specific advertising campaign, for example, or to send the responding recipient an item. In this case, the term item covers both digital and physical items/real items, such as advertising articles.

As a result, this inventive embodiment forms a method in which the at least one specific supplementary information element comprises a recipient identification in digital form and the recipient, having obtained the printed product, provides the user with an acknowledgement. This acknowledgement is associated with the relevant recipient by the user in a further step by means of the digital recipient identification and prompts a reaction from the user.

In a further inventive embodiment of the method, the acknowledgement from a specific recipient to the user is associated with the recipient profile of this recipient in a recipient database by means of the recipient identification and is stored in the recipient profile.

In the present preferred embodiment of the method, the user is accordingly a publisher or an advertising customer of a publisher, and the acknowledgement of a specific recipient is associated with a recipient profile in the database by means of the recipient identification and is stored in the recipient profile.

In a further inventive embodiment of the method, the advertising customer transmits the recipient identification, having obtained it, to the database in a request and obtains from this database a recipient information element which allows it to start interacting with the relevant recipient.

A person skilled in the art can see that with such use of specific supplementary information, there is sufficient done for the data protection for the recipient of specific supplementary information, because in one preferred embodiment the acknowledgement is provided by means of a response card which, although it can be read by anybody, shows the address of the advertising customer as a return address while the sender information—that is to say the recipient information—is coded and cannot be directly used or read by possible third parties. Through active acknowledgement to the advertising customer, the recipient of a specific supplementary information element of this kind grants the advertising customer the right to use his data. In this context, it does not matter whether this advertising customer obtains the data in coded form as in the present instance discussed above or whether it obtains them in uncoded form, i.e. directly.

In a further, preferred embodiment of the present invention, the acknowledgement by means of the response card with the RFID containing the specific supplementary information element, for example, is made not directly to the advertising customer but rather to the sender of the end product, for example the newspaper publisher. The publisher reads the specific supplementary information from the RFID tag and supplies it to the database. As in the case of the previously explained embodiment, the database notices that a certain recipient has decided to enter into communication with an advertising customer, and therefore changes the database entry preferably automatically. Furthermore, it sends the advertising customer the desired, previously specified data, for example the address, telephone number etc. In this embodiment, the advertising customer is saved the work of reading the RFID tag on the response card or a subproduct and obtains only that information about the respective recipient of the specific supplementary information element which is of interest to it, which is a relief and hence an added value for it. The bundled feedback from the publisher means that the advertising customer is now able either to make contact with the recipient of the specific supplementary information element directly or to send it a message and/or an item directly or indirectly.

In line with a further embodiment, the publisher also performs the further steps of interaction with the recipient, for example sending an item in the form of an advertising gift, and acts as a “full service provider” for the advertising customer, which obtains a detailed presentation regarding the success of the advertising campaign but does not itself need to be active.

Significant advantages of these inventive methods are not only economic but also ecological in nature. As an example, they avoid scattering resource-intensive advertising gifts or complex subproducts such as catalogs or the like to a broad, anonymous group of recipients, but rather a “pull mode” is used to send the item only to the interested party and the interacting recipient.

A person skilled in the art can naturally see that in one particularly preferred embodiment of the present invention, a particular recipient can be sent a plurality of specific supplementary information elements, for example in the form of a plurality of subproducts, which have different RFID tags and which for their part may again contain different specific supplementary information elements.

The text below will now discuss the interaction between the recipient of specific supplementary information and said recipient's communication options and subsequent actions. In one preferred embodiment, a particular recipient obtains an end product with a particular specific supplementary information element, for example. This specific supplementary information element is preferably again contained in a second memory area on an RFID tag. In a further preferred embodiment, the RFID tag contains only a single memory area. A person skilled in the art can see that it does not matter to the present invention whether an RFID tag has one, two or more memory areas in different hierarchies. If the recipient of an end product with a specific supplementary information element of this kind decides to make contact with the advertising customer, he can do this by sending the subproduct—designed as a response card—with the RFID tag to the informant/advertising customer, for example. The specific supplementary information element in the RFID tag can, as will be explained below, be called a “digital advertising gift”. It allows the user to distribute advertising gifts, preferably to selected recipients, for example purchasers and/or subscribers of a particular periodical, which cannot be added to the periodical directly. These may be advertising gifts which are too large, too heavy or too sensitive to be delivered with the periodical directly. A specific supplementary information element in the RFID tag on a children's magazine may entitle one to purchase an ice cream, for example, which for obvious reasons cannot be enclosed in the magazine.

As a result, this inventive embodiment forms a method in which the at least one specific supplementary information element comprises at least one digital item and/or at least one digital voucher.

Expressed in general terms, a further inventive embodiment proposes a method in which the digital voucher entitles the recipient to purchase an item, wherein the recipient purchases the item in digital form via a network, in digital form or as a real item from a counter upon presentation of the digital voucher or purchases the item at a reduced price, or obtains the item delivered as a real item following acknowledgement of the voucher to the user.

In a similar manner, this particularly preferred embodiment involves the recipient of the specific supplementary information element visiting the user directly or a partner company cooperating with said user and presenting the end product or subproduct which has the RFID tag having the specific supplementary information element. Said user now records that a particular recipient has provided it with acknowledgement and then prompts a particular reaction, preferably in the form of delivery or issue of an item, as mentioned in the preceding embodiments. To prevent multiple deliveries or issues to the same recipient, the memory in the RFID tag with the specific supplementary information element is preferably destroyed or voided when the item is purchased.

As a result, this inventive embodiment forms a method in which the interaction comprises a reaction selected from the following group: delivery of a digital item or a real item to the recipient, inclusion of the recipient as a participant in a competition, entitlement to a price reduction when purchasing certain further items or real items, award of special discounts and/or of free entry to an event, or the crediting of bonus points, for example from widely used bonus point collection systems.

A person skilled in the art can see that it is naturally also possible to overwrite the RFID tag or the information thereon. As a specific embodiment, reference will be made here, by way of representation, to a recipient who has obtained an RFID tag voucher from the advertising customer. The recipient therefore visits a kiosk, for example, or a sales outlet of the advertising customer or of a partner company, proves its identity by means of specific supplementary information in the RFID tag in order to purchase the item and obtains an advertising gift or is granted a price reduction. In comparison with conventional vouchers, the digital voucher has significant advantages in terms of security against corruption, simple voidability and traceability. When the authorization is checked, the specific supplementary information element is read by the user and can easily be stored in order to reevaluate a recipient profile in a recipient database.

As a result, this inventive embodiment forms a method in which the digital voucher is voided or destroyed following single use by the counter by modifying the digital voucher in the RFID tag.

In a further inventive embodiment, a method is characterized in that the digital voucher comprises an identification which is capable of association with the individual printed product and which allows the counter to ascertain the entitlement to purchase by interrogating a superordinate control system and to cancel the entitlement to purchase in the superordinate control system following a single purchase.

In line with a further preferred embodiment, provision is made for other means to also be used to make contact with the recipient of a specified supplementary information element of this kind and/or to provide it with a particular information element. A previously specified recipient who has obtained a specified end product with an RFID tag, containing a specific supplementary information element, is now able, in a further preferred embodiment of the present invention, to use a communication means—ideally to use his mobile telephone—to start to communicate with this RFID tag. This is preferably done by virtue of the recipient bringing the communication means/his mobile telephone into the active range of the RFID tag, so that the specific supplementary information element can interact with said communication means/the mobile telephone. In this way, a particular recipient obtains, by way of example, a ring tone or another audio information element, for example in the form of spoken advertisement, music or the like, on his mobile telephone. As a result, this inventive embodiment forms a method in which the recipient, having been provided with the printed product comprising RFID tags, reads the at least one specific supplementary information element in a read operation with a communication means or writes to the RFID tag.

A person skilled in the art can see that such communication in the form of individualized advertising usually prompts increased attention from the recipient. A person skilled in the art can also see that the communication means may also be a palmtop computer, a radio, a personal computer, a cordless telephone or any other communication means, for example, which can communicate with the RFID tag directly or indirectly, for example using an integrated reader. Instead of the reader, it is also possible to use a read/writer, which may by all means likewise be contained in the communication means, for example a mobile telephone.

The text below briefly describes the various options for communication (read/write operations) between the RFID tag associated with the product and the communication means. In this case, the RFID tag may either be in the form of an active tag, with a separate or autonomous current/voltage supply for a few hours, a few days or even a few weeks, or in the form of a passive tag, which is supplied with power by means of a communication means (inductive or capacitive coupling to the electromagnetic field of the communication means). The communication means may either be in the form of a mobile or portable apparatus, for example in the form of a mobile telephone, smart phone, PDA, RFID read/writer, e-book, audio/video media player with a screen or in the form of a mobile display apparatus, or else in the form of a static apparatus, for example in the form of a smart card reader in a computer.

If the communication means has a standard RFID interface, for example by virtue of the communication means containing an RFID read/write module (RFID reader), the communication and interaction between a standard RFID tag and the communication means are effected using a standard RFID protocol, for example at 13.56 MHz (radio frequency band; RF band), in the band around 433 MHz or between 850 MHz and 950 MHz (ultra high frequency band; UHF band) or in the band around 2.45 GHz or 5.8 GHz (microwave band). Other ISM frequency bands are possible. In this case, the frequency band matches the scope of information from the item; the more information that needs to be transmitted per unit time or the larger the memory of the RFID tags, the higher the frequency or the frequency band that is chosen. In this case, the wireless communication can be effected using both active and passive RFID tags. The communication and interaction are coded and modulated in this case using one of the customary methods, as are stipulated for the RF band in ISO/IEC 14443, ISO/IEC15693 or in the NFC specifications, for example.

When a communication means communicates with a passive RFID tag, which generally takes place over a short distance of up to 20 cm or less and in the case of which the start of the communication originates from or is initiated by the communication means, the operation of a passive RFID tag requires only a low transmission power, for example 50 mW in the RF band, 5 mW in the UHF band and 1 mW in the microwave band. Such transmission powers can be achieved without difficulty using common mobile telephones, for example.

If the product is equipped with an active RFID tag, the communication and interaction can also be initiated by the RFID tag in addition to the communication means, for example by virtue of the RFID tag attempting, during the active life provided, from a few hours (in the case of daily newspapers) to several weeks (in the case of monthly magazines), to send information to a communication means which is in direct proximity and which is cleared for communication and interaction with a selected or prescribed communication means (e.g. a mobile telephone with a particular number or SIM card) or which is associated therewith. This means that the user, for example, does not need to actively interrogate using the communication means, or the user is periodically referred to certain information, such as special offers or events, so long as it does not deactivate updating by the RFID tag, for example by writing a relevant information element to the RFID tag.

If the communication means does not have an integrated standard RFID reader, the communication between the communication means and the RFID tag takes place using the protocol or standard used or prescribed by the communication means (inherent protocol). In the case of a mobile telephone as communication means, this is a mobile radio protocol based on a mobile radio standard (e.g. GMS in the 900 MHz or 1.8 GHz band, UMTS in the 1.9 GHz to 2.2 GHz band), for example, or another communication protocol for the communication between at least two communication means or with another communication partner or background system or network (e.g. Wireless LAN, WiMax, Bluetooth, ZigBee in the band around 2.45 GHz or 5.8 GHz). In this case, the present invention involves the use of a specific new RFID tag which supports the relevant inherent protocol by virtue of the RFID tag, as an active or preferably passive RFID tag, emulating a communication partner associated with the communication means. When a mobile telephone is used with the mobile radio standard, the relevant RFID tag emulates a mobile radio base station to allow communication, for example. When Bluetooth is used as the communication protocol, an RFID tag, in line with a further embodiment, modulates a second communication means with a Bluetooth interface and protocol. It should be noted that the term RFID tag is also used for such tags in the present application, even though they are not tags based on the usual RFID standards or RFID protocols. In the present case, the term RFID tag is understood in a broad sense and is not restricted to the standardized RFID protocols. The RFID tag is in this case either in the form of a simple memory chip with hardwired logic for the communication and interaction or in the form of a uP chip with a memory which handles the communication and interaction.

The inherent protocol may also have an associated proprietary data protocol which is used—on the basis of the inherent protocol (as transport protocol)—to associate (code) the information in the communication means as in the RFID tag and which is used to read individual information elements (the item) from the RFID tag or to write them thereto. The proprietary data protocol is firstly implemented in the RFID tags directly as software (when the RFID tags are produced or written to). For the communication means, the proprietary data protocol is secondly only a possibly further or additional application which is loaded as software into the communication means (within the context of a software upload, upgrade or download) and then executed. The concept of a data protocol which is associated with, coordinate to or superordinate to the inherent protocol allows basically commercially available communication means to be used in an inventive apparatus or an inventive system and the matching or compatibility of the communication means to/with the RFID tags to be implemented in line with the present invention by means of software which is loaded into the communication means and/or executed by the communication means. The proprietary elements of the apparatus or method are therefore limited to the RFID tags, the data protocol and the communication means software.

An inventive printed product accordingly comprises at least one RFID tag which is capable of communication on the basis of at least one of the following protocols: mobile radio protocols, Bluetooth, RFID (standards), and comprises at least one specific supplementary information element in digital form.

In an inventive method, the RFID tag is capable of communication on the basis of at least one of the following protocols: mobile radio protocols, Bluetooth, ISO/IEC 14443, ISO/IEC 15693 or NFC specifications.

In another inventive method, the communication means comprises a transmission and reception unit which is capable of communication on the basis of at least one of the following protocols: mobile radio protocols, Bluetooth, ISO/IEC 14443, ISO/IEC 15693 or NFC specifications.

In addition, it is also possible for hardware of the communication means to be in a form such that the hardware can be reconfigured by means of software such that the hardware supports multiple communication protocols, i.e. multiple inherent protocols. In this case, an apparatus-specific and method-specific proprietary protocol can be implemented on a commercially available communication means by means of software, and without using additional specific hardware, said proprietary protocol both regulating the communication and interaction between communication means and RFID tag and detecting the data protocol. A corresponding proprietary protocol is firstly basically comparable with the various inherent protocols of the communication means, but differs in terms of modulation (demodulation) and encoding (decoding) of the communication, interaction and/or the data protocol, possibly also the output/transmission power, to a sufficient extent or such that mutual disturbance or influencing between the proprietary protocol and inherent protocol can be prevented. Configuration of the communication means in this manner provides multiple advantages: the use of commercially available communication means; the use of a simple proprietary protocol, because it is not necessary to give consideration to the inherent protocol, or the proprietary protocol does not need to be compatible with the inherent protocol; simpler and cheaper RFID tags because it is not necessary for the proprietary protocol to be implemented in the RFID tags for the purpose of emulating communication means or communication partners; use of the frequency bands, communication distances and output powers provided (in advance) by the communication means.

Even when an inherent protocol is used, the distance for the communication and interaction between RFID tag and communication means is generally up to 20 cm, i.e. the communication means is preferably brought into direct proximity (a few centimeters) to the RFID tag. Accordingly, it is either possible for the communication means to be operated at low or minimal output power (and still produces a sufficiently strong field for the current/voltage supply for a passive RFID tag) or else the RFID tag is recognized by the communication means as the communication partner in the closest surroundings or closest and is selected as primary in comparison with other possible communication partners, so that—when the proprietary protocol is used—there is no disturbance by or interaction with other communication means or communication partners. The output power limits the communication and interaction to a very small cell unit, comprising the communication means and the RFID tag, and suppresses, prevents or precludes communication and interaction by the communication means or the RFID tag with other communication means or communication partners in another very small cell unit or a superordinate cell unit.

In line with a further embodiment of the invention, the recipient is a sales outlet, for example, such as a newspaper kiosk. The inventive interaction allows significant simplification of the accounting for returns. In the present case, returns are understood to mean unsold end products of all kinds, usually unsold newspapers and magazines. Up until now, the sales outlets had to sort the returns according to title, had to manually count them and record them in lists and then return all or some of them to the publisher or to specialized distribution centers in order to allow accounting between these parties in line with the effectively sold number of printed products. When returns are sent back in part, the cover of the printed product or often just the newspaper header on the cover of the printed product is commonly removed. In line with the present invention, the product portion which is to be returned is now provided with the RFID tag, so that system-based contactless recording of the specific supplementary information element from the RFID tags makes complex and error-prone manual listing unnecessary. Since the specific supplementary information which is read is in digital form, it is possible to dispense entirely with the real, i.e. physical, transmission of the returns lists to the distributor or publisher, since the transmission is preferably likewise performed exclusively in digital form. Such digitized “accounting” firstly simplifies the business process for the distributor or publisher and secondly simultaneously provides it with supplementary information regarding the returns which could not be sold, and it is nevertheless less expensive than sending back the returns together with returns lists as previously. The digital information is obtained by the publisher even before the returned portions of the unsold products are received, which means that a publisher can react more quickly, for example, when certain printed products are quickly sold out from one sales outlet but have not been sold in a beneficial period by another and can prompt appropriate measures, such as moving these printed products to the more frequented sales outlet before the printed products become returns on the basis of their often limited currentness at the sales outlet with low demand.

In one inventive method, at least one RFID tag with a product identification is arranged on a cover of the printed products.

In another inventive method, the user is a publisher and the recipient is a sales outlet. As evidence of unsold printed products (returns), the sales outlet sends back these printed products or covers removed therefrom with the RFID tags connected thereto to the publisher, the recipient identification in the RFID tags allowing the publisher to associate the returns with the sales outlet.

In respect of the increasing spread of digital online media, an enormous pressure for currentness has arisen for media of all kinds. The inventive combination of classic printed product and RFID tag allows updating, or revaluation of the end product on the basis of currentness, which makes use of the inherent technical features of the RFID tags, particularly the rapid and contactless writability and readability of information, in line with another preferred embodiment of the invention. Accordingly, the specific supplementary information element for individualization is preferably not entered until shortly before the end product is dispatched or delivered or handed over to the recipient. In such an embodiment of the present invention, inherently and separately neutral products, preferably printers' products, could be provided with digital information having a high level of currentness. This can be done during the print further processing preferably prior to dispatch or even during the actual delivery of the end product by a deliverer or mail man or at a kiosk. In this case, the most current of messages, for example, are entered in digital form into the RFID memory of the relevant product. It is also possible to write recipient-specific messages, for example current stock market prices, to the RFID tag using a recipient profile at a time immediately preceding handover to the recipient or preceding dispatch, so that the end product is individualized and provided with supplementary information at a time only a little way in the past, while the actual printed product can be produced hours or, in the case of magazines or advertising inserts, days beforehand.

In one inventive embodiment of the method, the at least one RFID tag has the at least one specific supplementary information element written to it during the print further processing, preferably immediately before packaging or delivery.

From the statements hitherto, a person skilled in the art can see that the inventive concept can also be transferred to other areas of application. One representative application which may be mentioned is a kind of digital storage for the printers' products/end products at sales outlets, or theft prevention, for example. These use options merely require the sales outlets to use readers for reading the information on the RFID tags and to store the printed products in the range of action of their associated readers or to provide the access points to the sales area with such appliances in a known manner.

A person skilled in the art can also see that all points involved in the distribution process between producer/publishing house and recipient/end customer, such as carriers, sales outlets, newspaper delivery boys and others, can read and use the at least one specific supplementary information element and/or a further information element from an RFID tag associated with the printed products. It is thus possible to dispense with a cover on a stack of printed products, for example, which to date a newspaper delivery boy required in order to obtain quarter/road and/or recipient information. Instead of the cover, the newspaper delivery boy can read this information from a memory in a relevant RFID tag and use it for his distribution. If the RFID memory information contains details about delivery locations or interim storage facilities for packages of printed products in the form of GPS data, for example, the newspaper delivery boy can plan his distribution route in situ even for non-everyday errands and can then implement it more quickly than previously. Particularly in the case of printed products to be distributed which relate only to one quarter, one road or a portion thereof, for example because they contain local product information such as initiatives by a small firm, said printed products can nevertheless be delivered quickly and professionally, preferably together with the daily newspaper.

This embodiment of the present invention forms a method in which the at least one RFID tag on a product comprises at least one control information element and/or at least one product information element which controls at least one work step in the print further processing and/or in the product delivery or distribution.

In a further, particularly preferred embodiment of the present invention, the recipient of a specific supplementary information element is now able to bring his communication means into the range of action of this RFID tag so as thereby to prompt a read operation on the memory or second memory area of the RFID tag. The memory of the RFID tag in the present embodiment contains a specific supplementary information element in the form of an item which, in the present case, can preferably be displayed graphically, preferably as text and/or graphics on a display on a communication means in the form of a mobile telephone. As an example of such specific supplementary information, the RFID tag has been provided with information about stock market developments. Following the read operation by means of the communication means of the recipient, the stock market information is then reproduced on the display of the recipient's mobile telephone. A person skilled in the art can see the advantages of such an information source when, besides target-group-oriented advertising, it is also possible for up-to-the-minute, contemporary developments, for example in certain stock exchange centers, to be put onto the RFID tag even after a printed product has been created, for example not until just before it is dispatched to the particular recipient of the printed product.

In addition, in one particularly preferred embodiment, it is possible for a previously specified recipient to be sent a specific supplementary information element about a product, preferably a printed product with an RFID tag which is suitable for holding the specific supplementary information element. As in the case of the preceding embodiments, the recipient of a specific supplementary information element of this kind preferably uses his mobile telephone to make contact with the RFID tag and prompts a read operation from the memory area of the RFID tag to the mobile telephone or communication means. The specific supplementary information element is preferably itself an item, for example in the form of graphical and/or audio advertising or in the form of a voucher for another item or a preaddressed request to make contact with an advertising customer. In one preferred embodiment, such acknowledgement to the advertising customer is effected by means of a short message (SMS). As a result, the recipient of such an acknowledgement—for example the advertising customer/informant—can for its part direct a reaction, for example in the form of delivery of an item in the form of an advertising gift or the like, to the recipient of the specific supplementary information element.

As a result, this inventive embodiment forms a method in which the digital item comprises an image, text, video, audio or program file which is read by the recipient using the communication means and is made accessible as an image and/or audio information element.

In a further inventive embodiment, a method is formed in which the image and/or audio information element is made directly accessible to the recipient by the communication means or is transmitted in electronic form from the communication means to a consumer electronics appliance and is made accessible to him thereby.

If an active RFID tag instead of a passive RFID tag is put on the product, a person skilled in the art can see a once again enlarged field of use for the present invention. A specific supplementary information element from a printed product provided with such an RFID tag can now itself make contact with a suitable communication means of the end customer, recipient, sales outlet, etc. In one preferred embodiment of the present invention, the recipient of the specific supplementary information element obtains said information element in the form of an audio advertising message or melody, for example, on his mobile telephone. The fact that he has not actively requested the advertising message enhances the surprise effect and hence the effectiveness of the advertising message many times in comparison with printed advertising messages on the printed product. With the option of user-specific supplementary information on the active RFID tag of the associated product, it is possible to enhance the effect of this target-group-oriented advertising once again if, by way of example, the advertising message greets the recipient using his name. This implements the step in the direction of fully individualized advertising.

A person skilled in the art can see that the aforementioned embodiments can complement one another and/or that one or more embodiments, or forms of use of specific supplementary information, can be combined with one another.

### BRIEF DESCRIPTION OF THE DRAWINGS

The invention is explained below with reference to figures, which merely show exemplary embodiments and in which

FIG. 1 schematically shows a production and distribution process for individualized end products in line with a first embodiment of the present invention;

FIG. 2 schematically shows a production and distribution process for individualized end products in line with a further embodiment of the present invention, wherein the end products differ from one another and an informant and user of specific supplementary information are identical;

FIG. 3 schematically shows a production and distribution process for individualized end products in line with a further embodiment of the present invention, wherein an informant and a user of specific supplementary information are not identical;

FIG. 4 schematically shows a first option for use of a specific supplementary information element by a recipient;

FIG. 5 schematically shows a further option for use of a specific supplementary information element by a recipient;

FIG. 6 schematically shows yet another option for use of a specific supplementary information element by a recipient; and

FIG. 7 schematically shows yet another option for use of a specific supplementary information element by a recipient.

### DETAILED DESCRIPTION OF THE INVENTION

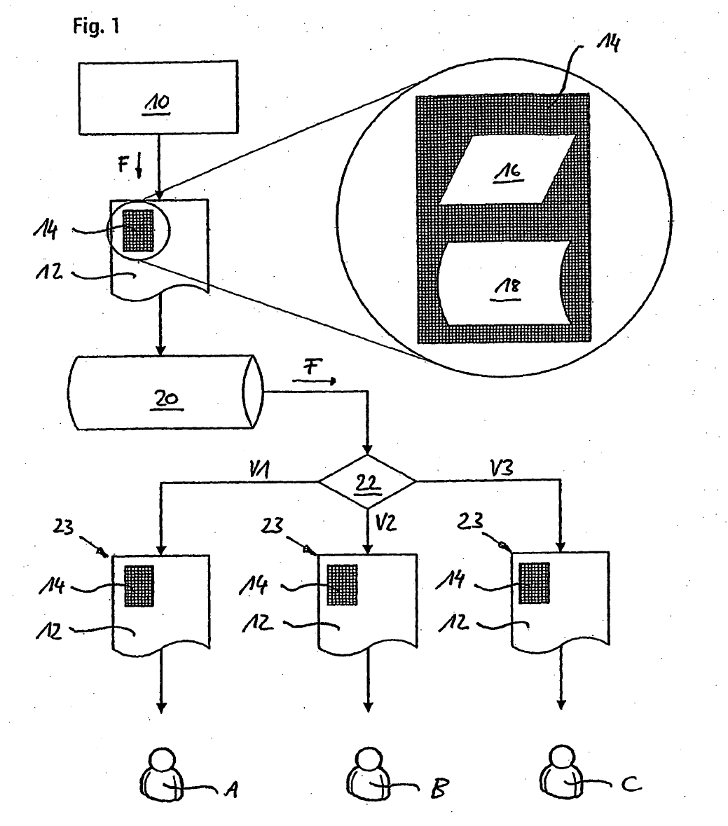

FIG. 1 shows a first embodiment of the present invention. A production process 10 is used to produce products 12, preferably using a rotation method, and then to convey them to a product further processing section 20, for example a drum, using a conveyor means. The products 12 are subsequently also called printed products or printers' products. Preferably during its actual production, each product is provided with an RFID tag 14, preferably permanently connected thereto, which is provided with information elements and/or specific supplementary information elements downstream in the conveying direction F at a write station—not shown. In this case, the preferred RFID tag 14 contains a first memory area 16 for holding information elements which are required for controlling subsequent processes in the product further processing section and/or for product identification, while a second memory area 18 is used for holding one or more specific supplementary information elements. The text below is primarily concerned with the use of this specific supplementary information element or these specific supplementary information elements.

To provide a better overview, FIG. 1 shows only one respective product in the product flow in the conveying direction F, said product representing a series of products which extends at least as far as a distributor 22. The conveying means used is a clamp conveyor or a ladder conveyor, for example, depending on the product. The product further processing section 20 is representative of collecting devices, assembly devices, stapling and cutting stations, inter alia.

A person skilled in the art can see that an individualized end product 23, for example a newspaper or a magazine, is first produced by the specific supplementary information element, preferably an addressee-specific information element in the RFID tags on the neutral products 12.

The distributor 22 is representative of a suitable distribution device and downstream third parties, for example newspaper delivery boys or contracts, which deliver the identical individualized end products 23 to various recipients A, B, C, in this case preferably end customers A, B, C, via various distribution channels V1, V2, V3.

The use of the specific supplementary information element contained on the respective RFID tags by the recipients A, B, C will be discussed in detail below.

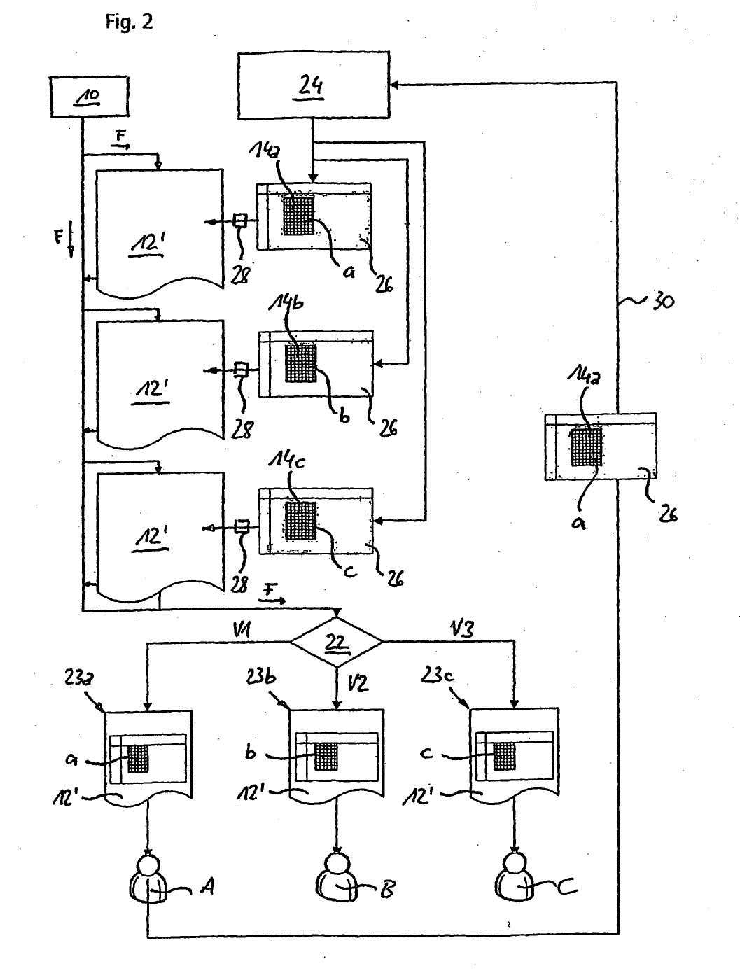

FIG. 2 will now be used to explain a further embodiment of the present invention. In this case, a user 24, preferably a publishing house, provides preferably structurally identical RFID tags 14a with various specific information elements a, b, c, so that individualized end products 23a, 23b, 23c are produced which, in contrast to the embodiment of the present invention explained with reference to FIG. 1, are therefore not identical.

In this embodiment, a multiplicity of identical products 12′ leave the production process in a conveying direction F by a conveying means—not denoted in more detail. The products 12′ are subsequently again also called printed products or printers' products. Viewed in a downstream direction, three workstations 28 are arranged along the conveying means, said workstations possibly being representative of a multiplicity of workstations. These workstations 28, preferably formed by investors, introduce inherently and separately identical subproducts 26 into the products 12′ serving as main products. From this, it can be seen that in this embodiment of the present invention the individualization is provided not by the main product 12 but rather by the subproducts 26 contained on the basis of the different specific supplementary information elements a, b, c. The RFID tags 14a, 14b and 14c are preferably structurally identical RFID tags, which by all means may be structurally identical to the RFID tag 14.

As in the case of the embodiment of the present invention which was explained with reference to FIG. 1, the individualized end products 23a, 23b, 23c specifically tailored to the recipients A, B, C reach the relevant recipients A, B, C by means of the distributor 22 via defined distribution channels V1, V2, V3. Preferably, the recipients A, B, C are representative of a multiplicity of recipients or end customers in the same target group for certain advertising. This means that, by way of example, advertising for baby articles can be specifically delivered only to families, without recipients who do not have babies being bothered thereby. Besides cost advantages and increases in efficiency on account of the clearly outlined target group of recipients, which as a subgroup of the total number of people is much smaller, this allows a significant contribution to be made to saving resources.

In the present embodiment of the invention, the subproducts 26 of all recipients A, B, C are in the form of response cards, for example, which do not differ from one another visually, since, besides advertising information and an invitation to take part in a competition and/or an advertising promise, they contain only the postal address of the user 24—in this case the publisher 24.

In the present case, the recipient A decides—as a representative of other recipients or recipient groups—to start to interact with the publisher 24 and to send back the preferably prefranked response card 26 to the publisher 24, for example in order to easily and conveniently request a trial subscription for a further printers' product. An acknowledgement 30 to the publisher 24 is in this case provided by mail. The publisher 24 can use a suitable reader to read the specific supplementary information element a, which in this case is formed by the recipient information element, stored digitally in the RFID tag 14a and can perform further steps in the interaction on a recipient-specific basis. The fact that it is not possible the specific supplementary information element a, b, c for the recipients A, B, C and possible third parties RFID tags 14a, 14b, 14c attached to the response card 26 without using a suitable appliance for reading the specific supplementary information element a, b, c means that the anonymity of the sender A can be assured to the greatest extent possible by protecting the sender information (i.e. the identity of the recipients A, B, C).

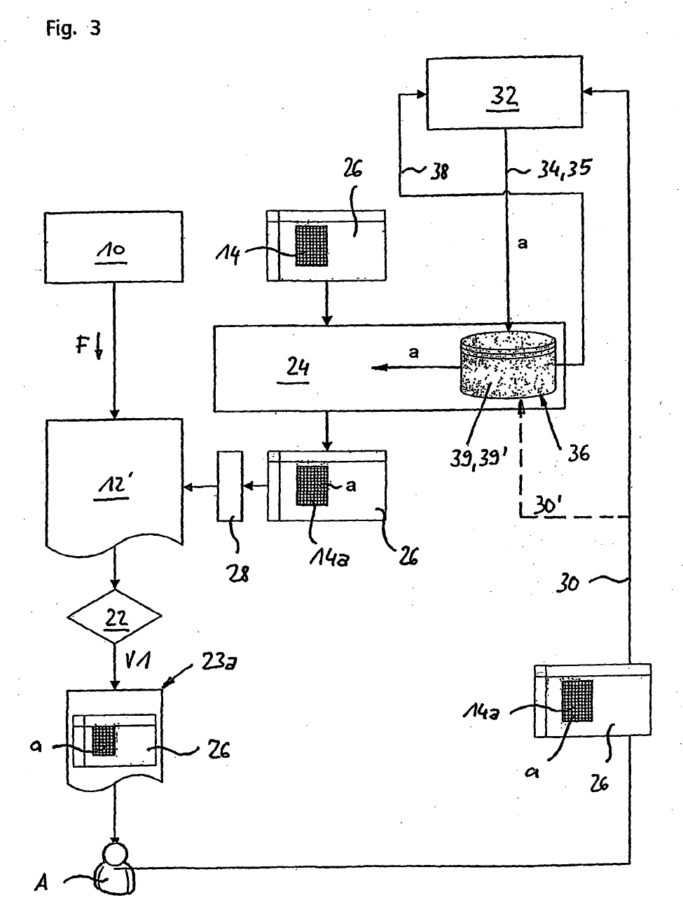

In another preferred embodiment of the present invention, which is illustrated in FIG. 3, the sender 24, preferably the publisher 24, is not simultaneously the user of the specific supplementary information element or of the value of the specific supplementary information element. Since the production of the individualized end products is identical to that in FIG. 2, a detailed description is dispensed with and only the differences over the embodiment of the present invention which is shown in FIG. 2 will be explained. In this embodiment, the user of the specific supplementary information element a on the RFID tag 14a of the subproduct 26 is an advertising customer 32 of the publishing house 24 which supplies the latter with the specific supplementary information element which is to be put onto the RFID tags. Said supplementary information element is supplied by entering it 35 into a database 36 of the publisher 24, which now has a database entry 39. When the subproducts 26 are produced, said database entry 39 is written to the memory, for example the second memory area 18 of the RFID tag 14a, as a specific supplementary information element a. In this case, a is preferably the coded recipient address of the recipient A. As a representative of various recipients or recipient groups, FIG. 3 shows only the recipient A of the individualized end product 23a with the specific supplementary information element a in order to provide a better overview. This recipient A uses the subproduct 26, preferably again designed as a response card, for interaction with the advertising customer 32 by means of the acknowledgement 30, for example by mail. The advertising customer 32 has a reader for reading the specific supplementary information element a contained on the response card 26. Since this specific supplementary information element a cannot be used directly by said advertising customer in the present form on the basis of the coding, it sends it in the form of a request 34 to the database 36. In the database 36, the request 35 received is associated with the recipient A by means of the coded specific supplementary information element a, an amended database entry 39a containing the advice that the recipient A has started to interact with the advertising customer 32 is created, and the advertising customer 32 is sent an appropriate recipient information element 38, which is preferably formed by an uncoded postal address for the recipient A, for the further use of the advertising customer 32.

In contrast to the embodiment just explained, an acknowledgement 30′ is sent, in one preferred embodiment of the present invention, not directly to the advertising customer 32 but rather again to the publisher 26, which reads the specific supplementary information element a from the RFID tag 14a and itself supplies it to the database 36, whereupon the database 36 provides the user/advertising customer 32 with the recipient information element 38. In this embodiment, the complexity of work for the advertising customer 32 is still relatively low, since it immediately obtains the recipient information element 38, which it can use directly, in response to its order by means of entry 35, this being an added value for the advertising customer 32.

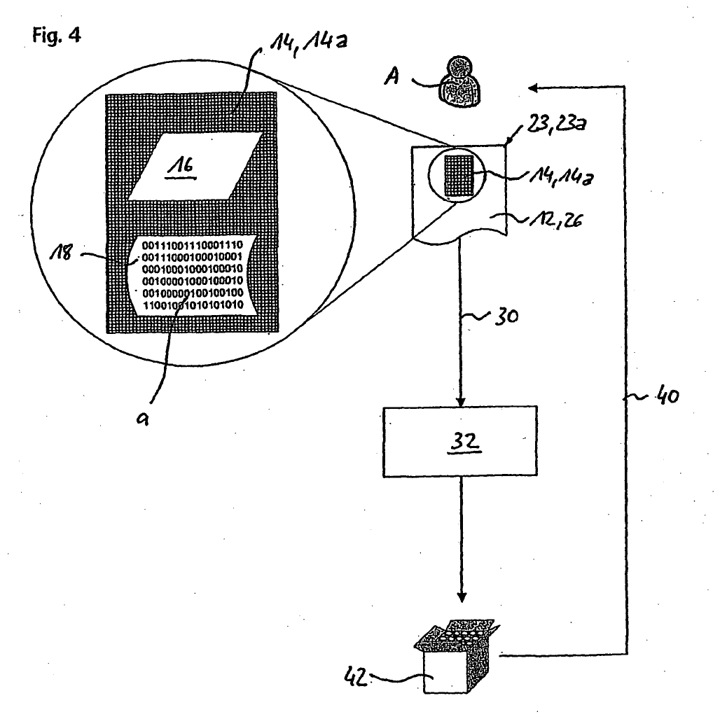

The text below uses FIGS. 4 to 7 to explain possible interactions between recipients and users of specific supplementary information elements on the basis of various embodiments of the present invention.

FIG. 4 has dispensed with showing the production and distribution process for an individualized end product 23, 23a to improve clarity. For information in this regard, reference is made to the preceding description. In the present case, the recipient A, who is preferably representative of a multiplicity of recipients, interacts with the advertising customer 32 again by means of the product 12, 26, which is provided with the specific supplementary information element, preferably again contained in the second memory area 18 of the RFID tag 14, 14a. The advertising customer 32 subsequently provides the interacting recipient A with an item 42 in the form of a real advertising gift 42, which preferably in turn has addressee-specific advertising enclosed with it. In a further embodiment of the present invention, the user 32 is a kiosk, for example, which is a partner company of a superordinate advertising customer. Such a situation actually makes it possible, for the first time, to give advertising gifts in the form of an ice cream 42, for example, to the recipient A via the kiosk 32, for obvious reasons. To prevent items 42 being given to the same recipient multiple times, the memory in the RFID tag 14, 14a with the specific supplementary information element a is preferably destroyed or voided when the item is purchased.

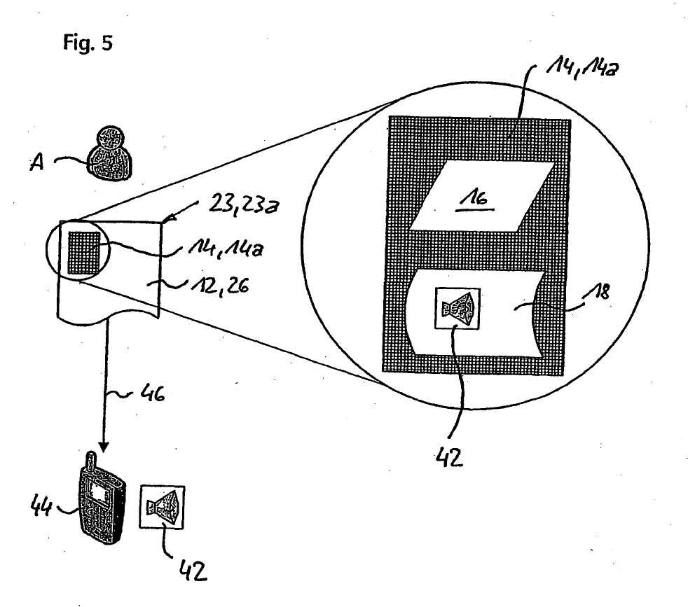

FIG. 5 illustrates a further preferred embodiment of the present invention. The recipient A has again been provided with an end product 23, 23a having a specific supplementary information element. In contrast to the preceding embodiments, the recipient A, who is preferably again representative of a multiplicity of recipients, does not actually first need to interact with the advertising customer or a user 32 in order to enjoy an item 42, since the specific supplementary information element on the RFID tag 14, 14a is itself the actual item 42—a digital item 42—for example in the form of a ring tone 42 for a mobile telephone 44 belonging to the recipient A. To redeem the item 42, the recipient A merely needs to bring his mobile telephone 44 into the range of action of the RFID tag 14, 14a, whereupon the item 42 is preferably automatically read in from the RFID tag 14, 14a by the mobile telephone 44 using a read operation 46.

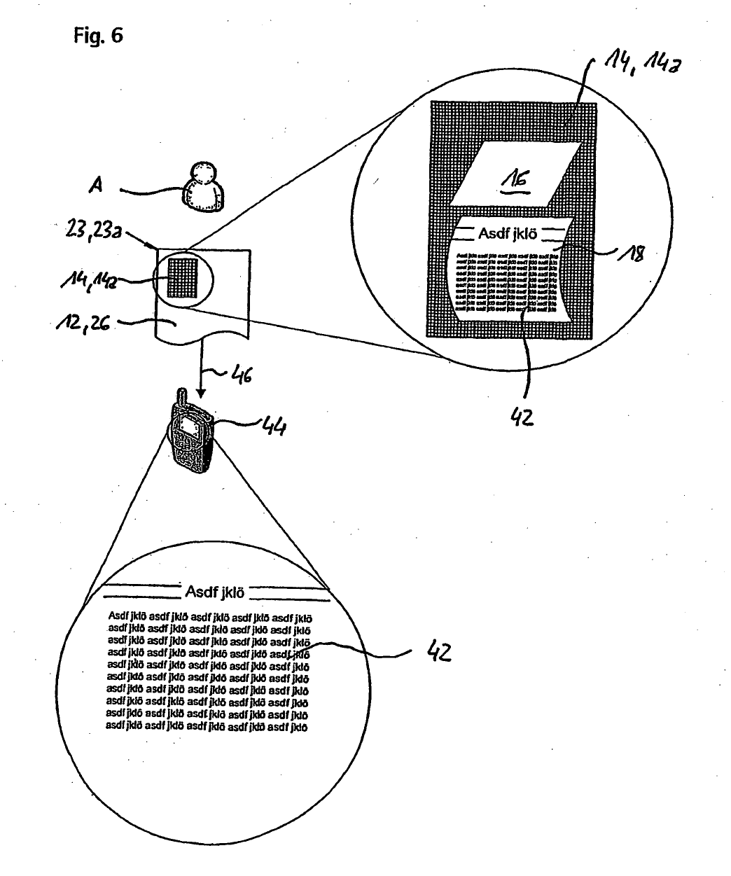

FIG. 6 shows a further preferred embodiment of the present invention, in which the item 42 is again present in the form of a digital item 42 in the memory of the RFID tag 14, 14a on the end product 23, 23a delivered to the recipient A. In contrast to the previously explained embodiment, the digital item 42 is not of an audible nature, but rather can be displayed graphically by a communication means, preferably again the mobile telephone 44 of the recipient. As an example of such an item 42, mention may be made of the latest stock market information 42, which the recipient A, preferably as a special subscriber, can read as an added value for his daily newspaper using his mobile telephone. The specific supplementary information elements therefore contain text which can be displayed on a display of the mobile telephone 44 and/or one or more graphics, which can furthermore be combined with audio information or tone sequences. In respect of the read operation 46 and the type of recipient A, reference is made to the previously explained embodiment.

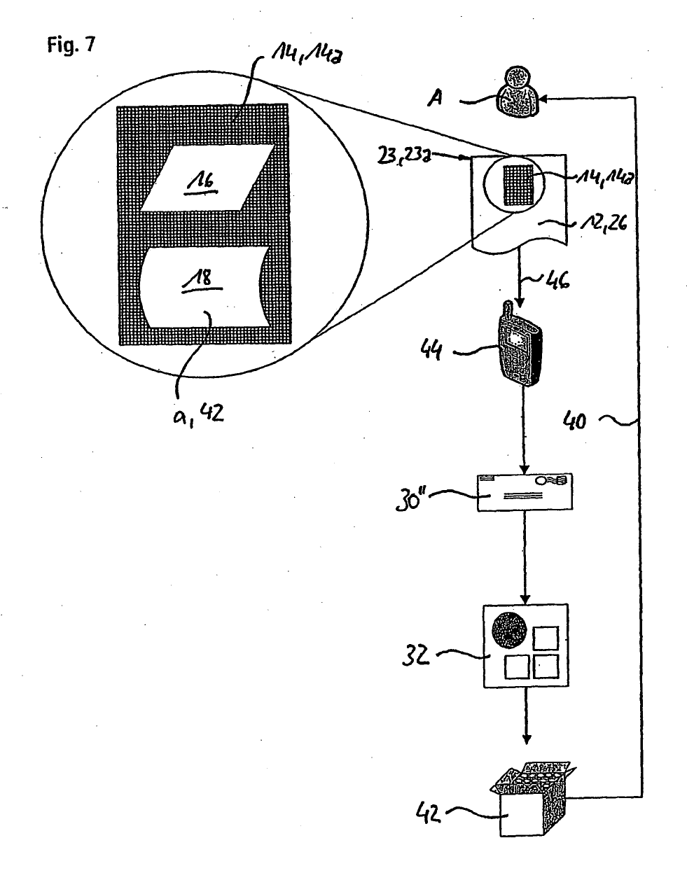

FIG. 7 is used to illustrate a further preferred embodiment of the invention, where the recipient A of a specific supplementary information element a, 42 is again preferably representative of a multiplicity of recipients. The recipient A has decided to use the specific supplementary information element a, 42 supplied to him to interact with the user 32. To allow him rapid and timely acknowledgement, the digital item 42 is preferably a preaddressed short message (SMS) on his mobile telephone 44. In this case, the read operation 46 for the specific supplementary information element takes place as mentioned above, and the recipient A can read an acknowledgement 30″ preferably merely by means of the command “send” on the mobile telephone 44, which is extremely convenient for him. If the acknowledgement 30″ from the advertising customer 32 is toll-free, the probability of interaction also increases greatly. In respect of the read operation 46 and the type of recipient A, reference is again made to a previously explained embodiment. In the present example, the user 32 interacts in response to the acknowledgement 30″ by providing the recipient A with a further item 42, this time preferably in the form of a real item 42.

1. A method for interaction between a user (32, 24) and at least one recipient (A, B, C) comprising:
characterized in that delivering a printed product (12, 23, 23a, 23b, 23c, 26), which comprises at least one RFID tag (14, 14a, 14b, 14c) which stores at least one specific supplementary information element (a, b, c, 42) in electronic form, to the recipient (A, B, C).

2. The method as claimed in claim 1, wherein the at least one specific supplementary information element (a, b, c) comprises a recipient identification in digital form, and the recipient (A, B, C), having obtained the printed product (12, 23, 23a, 23b, 23c, 26), provides the user (24, 32) with an acknowledgement which the user (24, 32) associates with the relevant recipient (A, B, C) by means of the digital recipient identification in a further step and which prompts a reaction from the user (32).

3. The method as claimed in claim 1 wherein the recipient (A, B, C), following delivery of the printed product (12, 23, 23a, 23b, 23c, 26) comprising RFID tags (14, 14a, 14b, 14c), reads the at least one specific supplementary information element (a, b, c) in a reading process with a communication means or writes to the RFID tag (14, 14a, 14b, 14c).

4. The method as claimed in claim 3 wherein the at least one specific supplementary information element (a, b, c) comprises at least one digital item (42) and/or at least one digital voucher.

5. The method according to claim 4 wherein the digital item (42) comprises at least one of an image, text, video, audio and program file which is read by the recipient (A, B, C) with the communication means and is made accessible as an image and/or audio information element.

6. The method as claimed in claim 5 wherein the image and/or audio information element (42) is made accessible to the recipient (A, B, C) by one of directly by the communication means and transmitted in electronic form from the communication means to a consumer electronics appliance and is made accessible by the consumer electronics appliance.

7. The method as claimed in claim 4 wherein the digital voucher entitles the recipient to purchase an item (42), wherein the recipient (A, B, C) purchases the item (42) in digital form via a network, in digital form or as a real item (42) from a counter upon presentation of the digital voucher or purchases the item at a reduced price, or obtains the item delivered as a real item (42) following acknowledgement of the voucher to the user (32).

8. The method as claimed in claim 7 wherein the digital voucher, having been used once, is voided or destroyed by the counter by modifying the digital voucher in the RFID tag (14, 14a, 14b, 14c).

9. The method as claimed in claim 7 wherein the digital voucher comprises an identification which is capable of association with the individual printed product (12, 23, 23a, 23b, 23c, 26) and which allows the counter to ascertain the purchase entitlement by interrogating a superordinate control system and to cancel the purchase entitlement in the superordinate control system after a single purchase.

10. The method as claimed in claim 2 wherein the recipient identification is generated prior to the storage in the RFID tag (14, 14a, 14b, 14c) on the basis of a recipient profile stored in a database (36) and is capable of explicit association with the recipient profile.

11. The method as claimed in claim 10 wherein the acknowledgement of a specific recipient (A, B, C) to the user (32) is associated with the recipient profile of this recipient (A, B, C) in a recipient database (36) by means of the recipient identification and is stored in the recipient profile.

12. The method as claimed in claim 10 wherein the user (32) is a publisher (24) or an advertising customer (32) of a publisher (24), and the acknowledgement (30, 30′, 30″) of a specific recipient (A, B, C) is associated with a recipient profile in the database (36) by means of the recipient identification and is stored in the recipient profile.

13. The method as claimed in claim 12 wherein the advertising customer (32) transmits the recipient identification, having obtained it, to the database (36) in a request (34) and obtains from the database (36) a recipient information element (38) which allows it to start interacting with the relevant recipient (A, B, C).

14. The method as claimed in claim 13 wherein the interaction comprises a reaction (40) selected from the following group: delivery (40) of a digital item (42) or a real item (42) to the recipient (A, B, C), inclusion of the recipient (A, B, C) as a participant in a competition, entitlement to a price reduction or special discount when purchasing certain further items or real items, award of free entry to an event, or the crediting of bonus points.

15. The method as claimed in claim 3 wherein the communication means comprises a transmission and reception unit which is capable of communication on the basis of at least one of the following protocols: mobile radio protocols, Bluetooth, ISO/IEC 14443, ISO/IEC15693 or NFC specifications.

16. The method as claimed in claim 1 wherein the RFID tag (14, 14a, 14b, 14c) is capable of communication on the basis of at least one of the following protocols: mobile radio protocols, Bluetooth, ISO/IEC 14443, ISO/IEC15693 or NFC specifications.

17. The method as claimed in claim 1 wherein the RFID tag (14, 14a, 14b, 14c) has the at least one specific supplementary information element written to it during the print further processing, preferably immediately before packaging or delivery.

18. The method as claimed in claim 1 wherein the printed product (12, 23, 23a, 23b, 23c, 26) is a multi-part printed product (12, 23, 23a, 23b, 23c, 26), comprising at least one main product (12) and one or more subproducts (26), wherein at least one of the main and/or subproducts, particularly inserts, postcards and/or advertising samples, is provided with the at least one RFID tag (14, 14a, 14b, 14c).

19. The method as claimed in claim 18 wherein the multipart printed product (12, 23, 23a, 23b, 23c, 26) is a printed product (12, 23, 23a, 23b, 23c, 26) individually compiled for a recipient, and the specific supplementary information element in the RFID tag (14, 14a, 14b, 14c) is a recipient-specific supplementary information element (a, b, c).

20. The method as claimed in claim 2 wherein at least one RFID tag (14, 14a, 14b, 14c) with a product identification is arranged on a cover of the printed products (12, 23, 23a, 23b, 23c, 26).

21. The method as claimed in claim 20 wherein the user (32) is a publisher (32) and the recipient (A, B, C) is a sales outlet which, as evidence of unsold printed products (12, 23, 23a, 23b, 23c, 26), returns the printed products (12, 23, 23a, 23b, 23c, 26) or covers separated therefrom with the RFID tags (14, 14a, 14b, 14c) to the user (32), wherein the recipient identification (38) in the RFID tags (14, 14a, 14b, 14c) allows the user (32) to associate the returns with the recipient (A, B, C).

22. The method as claimed in claim 1 wherein at least one RFID tag (14, 14a, 14b, 14c) for a product (12, 23, 23a, 23b, 23c, 26) comprises at least one control information element and/or at least one product information element which controls at least one work step in the print further processing (20) and/or in the product delivery (V1, V2, V3).

23. A printed product (12, 23, 23a, 23b, 23c, 26), comprising at least one RFID tag (14, 14a, 14b, 14c), wherein the at least one RFID tag (14, 14a, 14b, 14c) is capable of communication on the basis of at least one of the following protocols: mobile radio protocols, Bluetooth, RFID (standards), and comprises at least one specific supplementary information element in digital form.

24. A system for carrying out a method as claimed in claims 1.
